(19) United States
(12) Patent Application Publication
(10) Pub. No.: US 2018/0070527 A1
(43) Pub. Date: Mar. 15, 2018

(54) SYSTEMS FOR LEARNING FARMABLE ZONES, AND RELATED METHODS AND APPARATUS

(71) Applicant: CiBO Technologies, Inc., Cambridge, MA (US)

(72) Inventor: Ryan Richt, St. Louis, MO (US)

(21) Appl. No.: 15/701,339

(22) Filed: Sep. 11, 2017

Related U.S. Application Data
(60) Provisional application No. 62/385,927, filed on Sep. 9, 2016.

(51) Int. Cl. A01B 79/00; G01C 21/20; G06Q 50/02

(52) U.S. Cl. CPC A01B 79/005; G06Q 50/02; G01C 21/20

(57) ABSTRACT

Methods, systems, and apparatus, including computer programs encoded on computer storage media for improving inputs to an agronomic simulation model by learning farmable zones.

### CROSS-REFERENCE TO RELATED APPLICATION(S)

This application claims priority to and the benefit of U.S. Provisional Patent Application Ser. No. 62/385,927, filed on Sep. 9, 2016, which is hereby incorporated by reference herein to the maximum extent permitted by applicable law.

### TECHNICAL FIELD

This specification is directed towards systems and methods for improving the performance of an agronomic simulation model.

### BACKGROUND

Agronomy is the science and technology of producing and/or using plants (e.g., for food, fuel, fiber, land reclamation, etc.). Agronomy encompasses work in the areas of plant genetics, plant physiology, meteorology, soil science, etc. An agronomic simulation model can be used to predict the agronomic output of a particular geographic region based on a set of agronomic inputs. The predictions output by an agronomic simulation model may be limited by the accuracy of the set of input data provided to the agronomic simulation model and the parameters used to configure the agronomic simulation model.

### SUMMARY

Agronomic simulators are sometimes used to predict the agronomic output of a field based on the agronomic inputs to the field. For example, agronomic simulators may be used to predict the crop yield for a field, or to predict the effect of an agronomic intervention on the crop yield for a field. Generally, agricultural characteristics for a field are not homogenous throughout the entirety of the field. Instead, a field may be sub-divided into multiple farmable zones that have distinct agricultural characteristics. Accordingly, the agronomic outputs (e.g., crop yield) for a field can be improved by customizing the agronomic approach to each farmable zone, rather than using the same agronomic approach for the entire field.

Thus, techniques for identifying farmable zones of a field (e.g., techniques for sub-dividing a field into zones such that the portions of the field within a particular zone have similar agricultural characteristics, and the portions of the field in different zones have different agricultural characteristics) are needed. Some embodiments of such techniques are described herein.

In general, one innovative aspect of the subject matter described in this specification can be embodied in a method for learning farmable zones, including: obtaining agricultural data items from a device configured for agricultural analysis in a particular geographic region; identifying, from the obtained agricultural data items, a subset of the agricultural data items; generating a property model based on (i) the particular geographic region, and (ii) the subset of the agricultural data items; and generating a plurality of farmable zones that are each agriculturally distinct based on the subset of the agricultural data items.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The actions of the method may include segmenting the generated property model of the particular geographic region into a plurality of neighborhoods. The plurality of neighborhoods may be a plurality of substantially same sized neighborhoods. Segmenting the generated property model into the plurality of neighborhoods may include randomly segmenting the generated property model into the plurality of neighborhoods. Each neighborhood includes a respective portion of the particular geographic region with one or more territorial boundaries that fall within the particular geographic region.

Identifying a subset of the agricultural data items from the obtained agricultural data items may include removing one or more of the obtained agricultural data items each associated with a value of an agricultural characteristic that falls below a predetermined threshold. Identifying a subset of the multiple agricultural data items from the obtained agricultural data items may include selecting, for each of the neighborhoods, a subset of a set of the obtained agricultural data items that correspond to the respective neighborhood.

The actions of the method may include, for each particular neighborhood, generating a representative value for the particular neighborhood. The actions of the method may include, for each particular neighborhood, determining a mean of values of the agricultural data items residing within the particular neighborhood, wherein the representative value for the particular neighborhood is generated based on the determined mean.

Obtaining agricultural data items from a device configured for agricultural analysis in a particular geographic region may include receiving agricultural data from one or more harvesting machines. Obtaining agricultural data items may include obtaining, for each harvested plant, a set of agricultural data items, wherein the set of obtained agricultural data items for each harvested plant includes (i) one or more particular agricultural characteristics, (ii) a location, and (iii) a harvest time for the harvested plant. The one or more particular agricultural characteristics may include a weight of the harvested plant, an indication of whether the harvested plant was a bean, an indication of whether the harvested plant was a kernel, and/or a biomass of the harvested plant. The location may include a GPS location of a harvested plant at the time of harvest. The harvest time may include a date when a harvested plant was harvested.

Generating a plurality of farmable zones that are each agriculturally distinct based on the subset of the agricultural data items may include generating one or more clusters of agricultural data items based on at least a threshold amount of similarity in one or more agricultural characteristics amongst the subset of the agricultural data items. The actions of the method may include, for each cluster, merging neighborhoods that are encompassed by the cluster to create a farmable zone. Generating a plurality of farmable zones that are each agriculturally distinct based on the subset of the agricultural data items may include generating one or more clusters of agricultural data items based on the representative value of each neighborhood. The actions of the method may include, for each cluster, merging neighborhoods that are encompassed by the cluster to create a farmable zone.

The actions of the method may include providing the plurality of farmable zones as input to an agronomic simulation model. The actions of the method may include, for each input provided to the agronomic simulation model, tuning one or more values of one or more parameters of the agronomic simulation model based on an agriculturally distinct farmable zone on which the input is based. The one or more clusters may be generated using one or more of a K-means algorithm, a nearest neighbor algorithm, a graph cut clustering algorithm, a Felsen-Schwab clustering algorithm, a Dirichlet process mixture model, a Gaussian mixture model, a Principal Component Analysis (PCA) with thresholds, and a Markov Clustering Algorithm (MCL).

In general, another innovative aspect of the subject matter described in this specification can be embodied in a method for inferring one or more farmable zones, the method including: obtaining a property model; identifying a portion of the property model as a candidate farmable zone; providing the candidate farmable zone as an agronomic input to an agronomic simulation model; receiving an agronomic output from the agronomic simulation model, the agronomic output being based on processing of the agronomic input; determining whether the agronomic output includes one or more agricultural characteristics with one or more respective values that exceed a predetermined threshold; and in response to determining that the agronomic output does not include one or more agricultural characteristics with one or more respective values that exceed the predetermined threshold, adjusting one or more values of one or more parameters associated with the candidate farmable zone to create an adjusted candidate farmable zone.

Other embodiments of this aspect include corresponding computer systems, apparatus, and computer programs recorded on one or more computer storage devices, each configured to perform the actions of the methods. A system of one or more computers can be configured to perform particular actions by virtue of having software, firmware, hardware, or a combination of them installed on the system that in operation causes or cause the system to perform the actions. One or more computer programs can be configured to perform particular actions by virtue of including instructions that, when executed by data processing apparatus, cause the apparatus to perform the actions.

The foregoing and other embodiments can each optionally include one or more of the following features, alone or in combination. The actions of the method may include: providing the adjusted candidate farmable zone as a second agronomic input to the agronomic simulation model; receiving a second agronomic output from the agronomic simulation model, the second agronomic output being based on processing of the second agronomic input; determining whether the second agronomic output includes one or more values of one or more agricultural characteristics that exceed a predetermined threshold; and in response to determining that the second agronomic output includes one or more values of one or more agricultural characteristics that exceed the predetermined threshold, inferring that the adjusted candidate farmable zone is a farmable zone.

Identifying a subset of the property model as a candidate farmable zone may include identifying a portion of the property model as a candidate farmable zone. Identifying may include randomly identifying. The one or more agricultural characteristics may include a predicted crop yield.

Determining whether the agronomic output includes one or more values of one or more agricultural characteristics that exceeds a predetermined threshold may include determining whether the agronomic output includes data indicating whether one or more crop yield values exceed the predetermined threshold. Adjusting the one or more values of the one or more parameters associated with the candidate farmable zone to create an adjusted candidate farmable zone may include adjusting a size of the candidate farmable zone. Adjusting the one or more values of the one or more parameters associated with the candidate farmable zone to create an adjusted candidate farmable zone may include randomly adjusting a size of the candidate farmable zone. Adjusting the one or more values of the one or more parameters associated with the candidate farmable zone to create an adjusted candidate farmable zone may include adjusting a location of the candidate farmable zone. Adjusting the one or more values of the one or more parameters associated with the candidate farmable zone to create an adjusted candidate farmable zone may include randomly adjusting a location of the candidate farmable zone.

Particular embodiments of the subject matter described in this specification can be implemented so as to realize one or more of the following advantages. Agronomic inputs to an agronomic simulation model can be improved by analyzing agricultural data to identify farmable zones. Learning farmable zones allows for the parameters of an agronomic simulation model to be distinctly (e.g., uniquely) tuned for each learned farmable zone, which can yield more accurate parameters for the farmable zones. The use of these tuned parameters can improve the accuracy of predictions provided by the agronomic simulation model. Customized intervention plans can be created for each farmable zone. Agronomic output (such as crop yield) can be increased. Simulations can be performed using fewer computational resources.

Details of one or more embodiments of the subject matter of this disclosure are set forth in the accompanying drawings and the description below. Other features, aspects, and advantages of the subject matter will become apparent from the description, the drawings, and the claims.

The foregoing Summary, including the description of some embodiments, motivations therefor, and/or advantages thereof, is intended to assist the reader in understanding the present disclosure, and does not in any way limit the scope of any of the claims.

### BRIEF DESCRIPTION OF THE DRAWINGS

Certain advantages of some embodiments may be understood by referring to the following description taken in conjunction with the accompanying drawings. In the drawings, like reference characters generally refer to the same parts throughout the different views. Also, the drawings are not necessarily to scale, emphasis instead generally being placed upon illustrating principles of some embodiments of the invention.

FIG. 1A is a diagram of an example of a system for obtaining agronomic data.

FIG. 1B is a contextual diagram of a system for improving inputs to an agronomic simulation model by learning farmable zones.

FIG. 2 is a block diagram of an example of a system for improving inputs to an agronomic simulation model by learning farmable zones.

FIG. 3 is a flowchart of an example of a process for improving inputs to an agronomic simulation model by learning farmable zones.

FIG. 4 is a flowchart of an example of a process for inferring the existence of a farmable zone using an agronomic simulation model.

FIG. 5 is a diagram of a computer system.

### DETAILED DESCRIPTION

The following terms may be used in the detailed description:

As used herein, a “geographic region” refers to a portion of the surface of the earth.

As used herein, a “property model” refers to a conceptual representation of features of a geographical region.

As used herein, a “farmable zone” refers to an area of a geographic region that shares common values for at least one agronomic parameter. In some instances, a “farmable zone” include a set of non-spatially-contiguous areas all falling within the geographic region.

As used herein, a “candidate farmable zone” refers to an area of a geographic region selected for consideration as a farmable zone.

As used herein, an “agricultural characteristic” refers to one or more characteristics related to the production and/or use of plants (e.g., for food, feed, fiber, fuel, ornamentation, environmental or climatic modification, etc.). Agricultural characteristics may include, for example, cultivars and/or activities performed in the process of farming.

As used herein, “agricultural data” refers to data that relates to at least one agricultural characteristic.

As used herein, “agricultural data item” refers to data that corresponds to a particular agricultural characteristic. In some instances, an “agricultural data item” may include a feature vector generated based on other agricultural data items.

As used herein, “agriculturally distinct” (e.g., agriculturally unique) means different with respect to agricultural characteristics.

As used herein, “environmental characteristics” may refer to one or more climate conditions, weather conditions, atmospheric conditions, and/or soil conditions (e.g., of a geographic region, farmable zone, or candidate farmable zone). “Weather conditions” may include, but are not limited to, precipitation (e.g., rainfall, snowfall, hail, or other types of precipitation), wind, and solar radiation. “Atmospheric conditions” may include, but are not limited to, carbon dioxide levels, ozone levels, and smog conditions. “Soil conditions” may include, but are not limited to, microbial presence, insect presence, weed presence, nematode presence, fungal organism presence, water table presence, location of water tables, and topography.

As used herein, “agronomic parameters” may refer to one or more agricultural characteristics and/or environmental characteristics (e.g., of a geographic region, farmable zone, or candidate farmable zone).

As used herein, “agronomic simulation model” or “agronomic simulator” refers to a system that estimates and/or predicts an agronomic output based on one or more agronomic inputs.

As used herein, “agronomic input” or “input” refers to data that can be provided as input to the agronomic simulation model. Agronomic inputs may characterize, for example, agronomic parameters.

As used herein, “agronomic output” or “output” refers to data that is output by an agronomic simulation model. Agronomic outputs may characterize the results of agronomic activity.

As used herein, a “harvesting machine” refers to a machine that harvests plants.

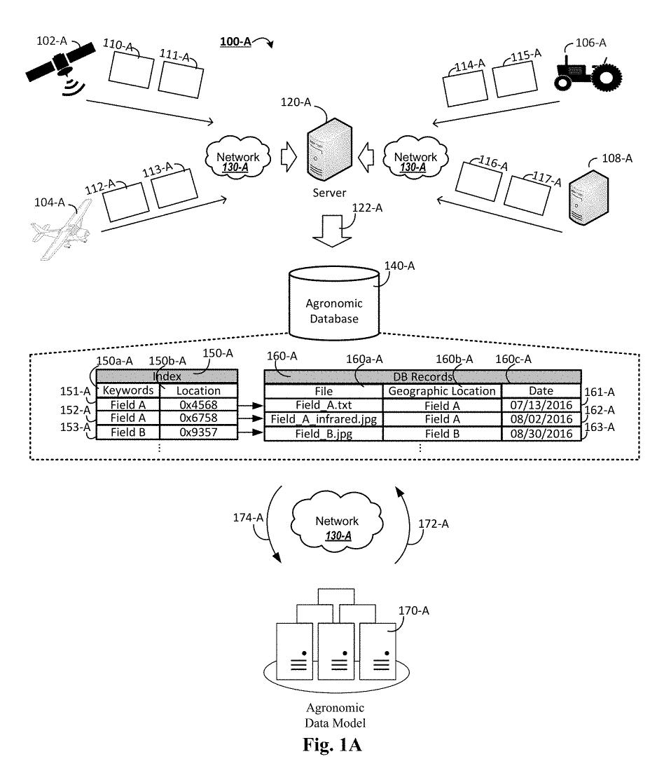

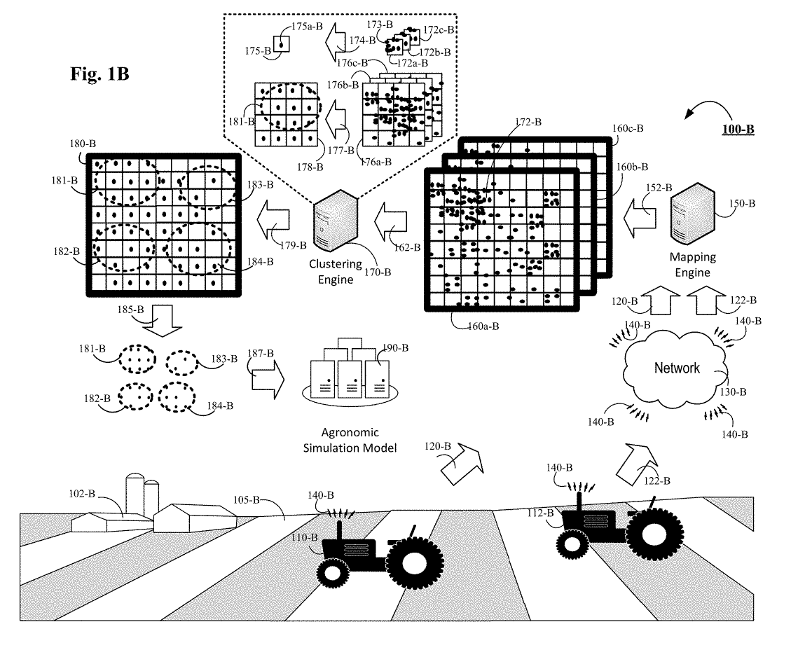

FIG. 1A is a diagram of an example of a system 100-A for obtaining agronomic data. The system 100-A may include at least one or more vehicles (e.g., a satellite 102-A, an airplane 104-A, or a tractor 106-A), at least one agronomic data providing server 108-A, a server 120-A, an agronomic database 140-A, and an agronomic data model 170-A.

Each of the vehicles may be equipped with one or more sensors capable of collecting agronomic data associated with a particular geographic region (e.g., a field of a farm). In some instances, the vehicles may include, for example, a satellite 102-A or an airplane 104-A equipped with one or more remote sensing devices for capturing image(s) of at least a portion of a geographic location. The images may include, for example, red-blue-green images, thermal images, infrared images, radar images, etc. Alternatively, or in addition, the vehicles may include a tractor 106-A equipped with one or more sensors capable of collecting agronomic data related to a particular portion of a geographic location that includes, for example, a plant's location (e.g., GPS location), the plant's weight, the plant's time of harvest, etc. Other types of vehicles may also be used to collect agronomic data associated with a particular portion of a geographic location. Such vehicles may include, for example, a drone. The agronomic data 110-A, 111-A, 112A, 113-A, 114-A, and 115-A captured by the vehicles may be transmitted via a network 130-A to a server 120-A. The network 130-A may include one or multiple networks, for example, a LAN, a WAN, a cellular network, the Internet, etc.

Alternatively, or in addition, agronomic data 116-A and 117-A may be obtained from one or more agronomic data providing servers 108-A. The server 108-A may, for example, house a database of historic agronomic data items from one or more geographic locations. For instance, the server 108-A may provide access to a database (e.g., a database hosted by a government agency, university, etc.) that tracks changes in agronomic data associated with particular geographic locations over time. The agronomic data 116-A, 117-A may be obtained from the server 108-A via a network 130-A.

Server 120-A may process the data 110-A, 111-A, 112-A, 113-A, 114-A, 115-A, 116-A, 117-A received via network 130-A and store 122-A the received data in an agronomic database 140-A. Processing the received data 110-A-117-A by server 120-A may include extracting relevant aspects of the received data for storage. Alternatively, or in addition, processing of the received data 110-A-117-A by server 120-A may include generating an index 150-A that can be used to efficiently access and retrieve the data 110-A-117-A once the data 110-A-117-A are stored as records 160-A in the agronomic database 140-A. The agronomic database 140-A may be hosted on the server 120-A. Alternatively, or in addition, the agronomic database may be hosted by one or more other servers.

The index 150-A may include one or more fields for each index entry 151-A, 152-A, 153-A, etc. Examples of index fields may include, for example, a keyword field 150a-A, a storage location field 150b-A, etc. In the example of system 100-A, the agronomic database 140-A may be configured to receive one or more search parameters for one or more database records (for example, search parameters requesting data related to “Field A”). In response to the receipt of such search parameters, the agronomic database 140-A may identify all the index entries matching the search parameter, identify the storage location 150b-A associated with each matching index entry, and access the database record(s) stored at the identified storage location(s). Though a particular example of an index 150-A and index fields 150a-A, 150b-A are provided herein, the present disclosure need not be so limited. Instead, any type of index may be used to index the data 110-A-117-A received and stored in the agronomic database 140-A so long as the data stored in the agronomic database 140-A can be accessed by the agronomic data model 170-A.

The data 110-A-117-A may be stored in the agronomic database 140-A as one or more database records 160-A. The agronomic database 140-A may store records in any logical database form (for example, a relational database, hierarchical database, column database, etc.). Instead of requiring the use of a particular logical database schema, the agronomic database 140-A may only require a configuration that allows the agronomic data stored by the agronomic database 140-A to be accessed by the agronomic data model 170-A. Some examples of the types of data that may be stored in agronomic database 140-A include a file 160a-A (e.g., an image file), a geographic location 160b-A associated with the stored file (or other agronomic data), a date 160c-A the data were captured, or the like. Any suitable type of data may be stored, and in some embodiments the types of data stored are determined based on the type of received data 110-A-117-A.

One or more server computers may provide access to the agronomic data model 170-A. The agronomic data model 170-A may request 172-A data from the agronomic database 140-A via a network 130-A. The requested data may be data that can be used to analyze agronomic characteristics associated with a particular geographic location. Agronomic data responsive to the agronomic data model's 170-A request 172-A may be returned 174-A from the agronomic database 140-A to the agronomic data model 170-A via one or more networks 130-A. The agronomic data model 170-A may use the agronomic data returned 174-A from the agronomic database 140-A as an agronomic input to the model.

FIG. 1B is a contextual diagram of a system 100-B for improving (e.g., optimizing) inputs to an agronomic simulation model by learning farmable zones of a field, relative to one or more inputs to the agronomic simulation model independent of the learning of the farmable zones. The learned farmable zones can improve the inputs to an agronomic simulation model because the agronomic model can process each discrete farmable zone based on each respective farmable zone's distinct (e.g., unique) agricultural characteristics as opposed to prior methods that process inputs that generally treat an entire field as having generally homogenous agricultural characteristics throughout.

The system 100-B can be used to increase crop yields produced by a farm 102-B—relative to crop yields produced independent of the use of the farmable zones learned by the subject matter described by this specification—by analyzing agricultural characteristics of a field 105-B to learn the field's farmable zones. A field (e.g., field 105-B) is a geographic region associated with multiple different agricultural characteristics. The crop yield produced by a particular field is influenced by the agricultural characteristics of the field. Such agricultural characteristics may include, for example, rainfall, soil depth, soil PH, nitrate levels, phosphorous levels, plant population, ponding, elevation, lateral runoff, existence of irrigation pipes, or the like.

Generally, agricultural characteristics for a particular field are not homogenous throughout the entirety of the field 105-B. Instead, a particular field (e.g., field 105-B) may be sub-divided into multiple farmable zones that may each be associated with a set of agricultural characteristics that may be agriculturally distinct (e.g., unique). Accordingly, the crop yield for a field 105-B can be improved (e.g., maximized), for example, by customizing the agronomic approach to each farmable zone of the field 105-B relative to methods that do not customize an agronomic approach per each farmable zone learned by the subject matter of this specification. Methods that do not customize an agronomic approach per each farmable zone learned by the subject matter of this specification include, for example, those methods that apply the same agronomic approach to the entirety of field 105-B as a whole.

The system 100-B collects agricultural characteristics that can be analyzed to learn farmable zones by using one or more vehicles 110-B, 112-B that travel over the field 105-B. The vehicles 110-B, 112-B may be equipped with one or more agronomic sensors that are configured to detect the values associated with one or more agricultural characteristics associated with a portion of a field 105-B. In one implementation the vehicles 110-B, 112-B may include harvesting vehicles. In such instances, the harvesting vehicles may be configured to obtain the values associated with one or more agricultural characteristics for each plant (or set of plants) that is harvested. For instance, when a plant is harvested, the harvesting vehicle may obtain an item of agricultural data associated with the harvested plant that includes the plant's location (e.g., GPS location), the plant's weight, the plant's time of harvest, etc. Alternatively, or in addition, agronomic sensors associated with the harvesting vehicle may determine whether a bean or kernel was harvested. Alternatively, or in addition, the agronomic sensors associated with the harvesting vehicle may obtain an indication of the plant's biomass. In addition to the value associated with one or more agricultural characteristics, an item of agricultural data may also include metadata that provides an indication as to the meaning of each value. For example, metadata associated with an item of agricultural data may indicate that a value of 1:00 pm EST is a plant's harvest time. The detected agricultural data items for each harvested plant are transmitted 120-B, 122-B to a mapping engine 150-B through a network 130-B using one or more communications links 140-B. The network 130-B may include, for example, one or more of a LAN, WAN, cellular network, the Internet, etc.

The system 100-B may include a mapping engine 150-B configured to obtain, from one or more different sources, agricultural data items that can be used to generate one or more property models of the field 105-B. For instance, the mapping engine 150-B may be configured to receive 120-B, 122-B multiple agricultural data items from the vehicles 110-B, 112-B via a network 130-B using one or more communication links 140-B. Alternatively, or in addition, the mapping engine 150-B may receive multiple agricultural data items related to the field 105-B from one or more remote sensing devices (e.g., images captured by one or more imaging devices mounted to a plane, drone, satellite, or other vehicle), one or more agronomic databases, etc.

The mapping engine 150-B may generate a feature vector for one or more of the received agricultural data items. Each feature vector provides a representation of one or more numerical values associated with one more agricultural characteristics associated with particular portions of the field 105-B. For example, in one implementation, a feature vector may describe the values of one or more agricultural characteristics associated with a particular plant harvested from field 105-B. Alternatively, or in addition, a feature vector may represent the values of one or more agricultural characteristics associated with a portion of the field 105-B where the plant was planted. Alternatively, or in addition, a feature vector may represent values indicative of the climate associated with the geographic region where the field 105-B resides. Yet in other implementations, a single feature vector may include values representative of agricultural characteristics associated with a plant that was harvested, a portion of the field 105-B, the climate associated with field 105-B, and etc.

The mapping engine 150-B is configured to generate one or more property models 160a-B, 160b-B, 160c-B of the field 105-B based on the feature vectors. The property models may each include, for example, a vector space model that is related to the field 105-B. Each property model 160a-B, 160b-B, 160c-B of field 105-B may be segmented into a plurality of neighborhoods residing within the boundaries of the field 105-B. For instance, with reference to FIG. 1B, each square of the grid associated with each property model 160a-B, 160b-B, 160c-B may represent a respective neighborhood. Moreover, each black dot on the property models 160a-B, 160b-B, 160c-B displayed in FIG. 1B may represent a feature vector that has been generated based on feature vectors corresponding to agricultural data items associated with the particular neighborhood (e.g., square on the grid) where the dot resides. Though squares are used to describe neighborhoods in this example, neighborhoods may be conceptually represented as any N-sided polygon, where “N” is any positive, non-zero integer value. In some implementations, such neighborhoods may be segmented in accordance with a predetermined plan (e.g., segment the field 105-B into squares that each have a width and length of 4 feet). Alternatively, or in addition, however, fields may be randomly segmented into neighborhoods, and neighborhoods may be randomly segmented into smaller neighborhoods. In some implementations, random segmentation may result in the generation of neighborhoods of different shapes and sizes.

In some implementations, the mapping engine 150-B may generate one or more property models 160a-B, 160b-B, 160c-B of the field 105-B based on a subset of the generated feature vectors. Selecting only a subset of the generated feature vectors to generate the property model can improve the performance of the system 100-B, relative to generating property models using all of the generated feature vectors, by reducing the amount of computational resources necessary to generate and process each respective property model 160a-B, 160b-B, 160c-B. In one implementation, the subset of feature vectors may be determined by randomly selecting a threshold number of feature vectors from each neighborhood for inclusion in the corresponding property model 160a-B, 160b-B, 160c-B. Alternatively, the subset of feature vectors may be determined by selecting only feature vectors that are associated with one or more agronomic parameters having values that exceed a predetermined threshold. Such a selection of only a subset of the feature vectors generally does not result in a reduction in accuracy of the model because the neighborhoods are relatively small geographic portions of the field 105-B. In some implementations, initial neighborhoods may be created as small as 2 square feet, 4 square feet, 6 square feet, or the like. Though there are implementations that can improve the system 100-B by generating a property model 160a-B, 160b-B, 160c-B based on only a subset of the collected feature vectors, the subject matter of the present disclosure need not be so limited. For instance, there may be other implementations that can generate a property model using more than a subset of the generated feature vectors, or even all of the generated feature vectors, to generate a property model.

Each respective property model 160a-B, 160b-B, 160c-B may include the same set or different sets of agricultural characteristics that were obtained via another collection method. For example, the property model 160a-B may be generated based on agricultural characteristics collected by the vehicles 110-B, 112-B, the property model 160b-B may be generated based on data that has been remotely sensed, the property model 160c-B may be based on property-specific agricultural characteristics obtained, for example, from one or more agronomic databases. It is also considered that other methods can be used to collect agricultural characteristics related to a field 105-B such as, for example, geographical surveys.

The mapping engine 150-B may provide the generated property models 160a-B, 160b-B, 160c-B to a clustering engine 170-B, which clusters neighborhoods to learn farmable zones. In some implementations, the clustering engine 170-B may analyze the property models 160a-B, 160b-B, 160c-B on a neighborhood-by-neighborhood basis. For instance, the clustering unit 170-B may identify a particular neighborhood 172-B from each property map (e.g., neighborhoods 172a-B, 172b-B, 172c-B) and obtain the feature vectors 173-B used to generate the portion of the property models 160a-B, 160b-B, 160c-B corresponding to the particular neighborhood 172-B. Then, the clustering engine 170-B can generate an improved (e.g., optimized) neighborhood 175-B that includes a representative value 175a-B for the feature vectors 173-B. This process described with respect to a particular neighborhood 172-B can be used for each neighborhood of the field 105-B to generate an improved (e.g., optimized) property model 180-B based on the set of multiple property models 160a-B, 160b-B, 160c-B. However, the present disclosure need not be so limited to analyzing property models on a neighborhood-by-neighborhood basis. Instead, the clustering engine 170-B may analyze larger portions of a set of property models 160a-B, 160b-B, 160c-B to generate an improved (e.g., optimized) property model.

As previously discussed, feature vectors are conceptually indicated on property models 160a-B, 160b-B, 160c-B in FIG. 1B using black dots. Similarly, the black dots on the improved (e.g., optimized) property model 180-B are conceptually indicative of the representative value that is generated for the set (or subset) of feature vectors in each neighborhood of the property models 160a-B, 160b-B, 160c-B.

In some embodiments, the clustering engine 170-B may analyze representative values of neighborhoods to cluster together neighborhoods associated with representative values that satisfy a predetermined similarity threshold. For instance, the clustering engine may receive one or more portions of multiple property models 176a-B, 176b-B, 176c-B, analyze portions of the property models 176a-B, 176b-B, 176c-B to generate 177-B an improved (e.g., optimized) property model 178-B that includes, for each particular neighborhood, a representative value of the feature vectors for the particular neighborhood, and then generate a cluster 181-B for those representative values that satisfy a predetermined level of similarity. The representative values may be clustered using one or more clustering processes such as, for example, K-means algorithm, nearest neighbor algorithm, graph cut clustering algorithm, Felsen-Schwab clustering algorithm, Dirichlet process mixture model, Gaussian mixture model, Principal Component Analysis (PCA) with thresholds, Markov Clustering Algorithm (MCL), or the like.

A particular clustered set of representative values (e.g., cluster 181-B) is indicative of an agriculturally distinct (e.g., unique) farmable zone of the field 105-B. Each cluster is a grouping of neighborhoods, or portions thereof, that share similar agricultural characteristics since the cluster 181-B is based on representative values derived from feature vectors based on agricultural characteristics of the field 105-B. In some implementations, the clustering engine may merge one or more neighborhoods encompassed within a particular cluster to create a farmable zone. Because each farmable zone is the result of a cluster of similar representative values derived from the agricultural characteristics of neighborhoods of the field 105-B, a particular farmable zone may be (1) composed of agriculturally similar neighborhoods (e.g., because the particular farmable zone was identified as being comprised of neighborhoods having representative values with a predetermined level of similarity), and also (2) agriculturally distinct (e.g., unique) from one or more other learned farmable zones (e.g., because other farmable zones are composed of different representative values that were not determined to be within a predetermined level of similarity to the representative values of the particular farmable zone).

The output of the clustering engine 179-B may be an improved (e.g., optimized) property model 180-B of the multiple property models 160a-B, 160b-B, 160c-B. Based on processing performed by the clustering engine 170-B, multiple farmable zones 181-B, 182-B, 183-B, 184-B are identified. Each farmable zone of the multiple farmable zones 181-B, 182-B, 183-B, 184-B is provided as a distinct agronomic input 187-B to the agronomic simulation model 190-B. For each farmable zone of the multiple farmable zones 181-B, 182-B, 183-B, 184-B, the agronomic simulation model 190-B may be distinctly (e.g., uniquely) configured to improve (e.g., maximize) the crop yield of each respective farmable zone. Such zone-by-zone analysis may result in a higher crop yield than merely using the agronomic simulation model to analyze a field 105-B as a single, homogeneous region because the agricultural characteristics of each particular farmable zone can be distinctly (e.g., uniquely) addressed to improve (e.g., maximize) each respective farmable zone's output. Some embodiments of the agronomic simulation model 120-B are discussed in further detail in U.S. patent application Ser. No. 15/259,030, titled “Agronomic Database and Data Model” and filed on Sep. 7, 2016, the contents of which are hereby incorporated by reference herein to maximum extent permitted by applicable law.

For each particular neighborhood of a field 105-B, the clustering engine 170-B may analyze the received property models to determine, based on the set (or subset) of feature vectors associated with the neighborhood, a representative value indicative of the characteristics of the neighborhood. The representative value may be, for example, a representative feature vector derived from the set (or subset) of feature vectors associated with a particular neighborhood. Representative values may be generated, or otherwise derived, from a set (or subset) of feature vectors in any suitable way. For instance, in some implementations, a representative value may be randomly selected from the set (or subset) of feature vectors associated with a particular neighborhood. Alternatively, or in addition, the representative value may be generated from the mean of the set (or subset) of feature vectors associated with a particular neighborhood. However, the present disclosure need not be so limited, and other methods of generating, or deriving, a representative value are considered to fall within the scope of the present disclosure.

In some embodiments, the clustering engine 170-B generates the representative values of the feature vectors associated with each neighborhood of a property model, and then clusters the neighborhoods based on the representative values. Generating the representative values representing the features vectors associated with each neighborhood of a property model, and later clustering neighborhoods based on the representative values can improve the performance of the system 100-B, relative to clustering neighborhoods independent of the representative values, by reducing the amount of processing power and memory resources used to learn farmable zones. For instance, significantly less computational resources may be used to process the respective representative values of the particular subsets of feature vectors provided in the improved (e.g., optimized) property model 180-B than the entire set of feature vectors originally generated by the mapping engine 150-B. Moreover, clustering neighborhoods based on the representative values for each neighborhood can further improve performance relative to clustering neighborhoods based on the subset of feature vectors included in the property models 160a-B, 160b-B, 160c-B.

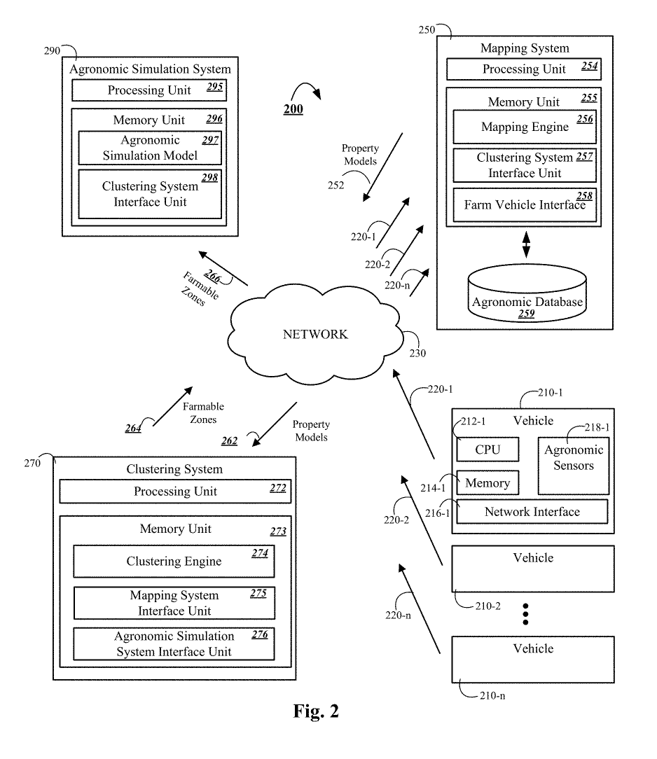

FIG. 2 is a block diagram of an example of a system 200 for improving (e.g., optimizing) inputs to an agronomic simulation model by learning farmable zones, relative to one or more inputs to the agronomic simulation model independent of the learning of the farmable zones. The system may include a mapping system 250, a clustering system 270, an agronomic simulation system 290, and/or one or more vehicles 210-1, 210-2, 210-n equipped with agronomic sensors.

The mapping system 250 may include one or more computers that each include at least a processing unit 254 and a memory unit 255. The processing unit 254 includes one or more processors configured to execute the instructions associated with each of one or more software modules stored in the memory unit 255. The memory unit 255 includes one or more storage devices (e.g., RAM, flash memory, storage disks, etc.). The memory unit 255 stores software modules used to perform the actions of methods of the mapping engine described by this specification. In particular, the software modules stored by the memory unit 255 may include a module implementing a mapping engine 256 that may be configured to perform one or more of the actions of methods as described with respect to FIGS. 1B, 3, and 4. For example, the mapping engine 256 may be configured to generate agronomic feature vectors that are derived from obtained agronomic data items. In addition, the mapping engine 256 may be configured to select a subset of the generated feature vectors that can be used to generate a property model. In addition, the mapping engine 256 may be configured to generate a property model based on the generated agronomic feature vectors, and provide the property model to one or more other components of system 200.

The memory unit 255 also stores software modules related to a clustering system interface unit 257 and a vehicle interface 258. The clustering system interface unit 257 may facilitate networked communication between the mapping system 250 and the clustering system 270 via the network 230. For example, the clustering system interface unit 257 may be configured to transmit one or more property models 252 to the clustering system 270 through the network 230. The network 230 may include, for example, one or more of a LAN, WAN, cellular network, the Internet, etc.

The vehicle interface 258 may facilitate networked communication between the mapping system 250 and one or more vehicles 210-1, 210-2, 210-n, wherein “n” is any positive, non-zero integer value. For example, the vehicles interface 258 may be configured to receive one or more agricultural data items 220-1, 220-2, 220-n detected by agronomic sensors mounted to a vehicle, and transmitted by the respective vehicle's network interface 216 through the network 230.

In addition, the mapping system 250 may also include an agronomic database 259. The agronomic database 259 stores agronomic data such as property specific agronomic inputs based on historical agricultural characteristics associated with one or more fields, one or more geographic regions, or the like.

The clustering system 270 may include one or more computers that each include at least a processing unit 272 and a memory unit 273. The processing unit 272 includes one or more processors configured to execute the instructions associated with each of one or more software modules stored in the memory unit 273. The memory unit 273 includes one or more storage devices (e.g., RAM, flash memory, storage disks, etc.). The memory unit 273 stores software modules used to perform the actions of methods of the clustering engine described by this specification. In particular, the software modules stored by the memory unit 273 may include a module implementing a clustering engine 274 that may be configured to perform one or more of the actions of methods as described by FIGS. 1B, 3, and 4. For example, the clustering engine 274 may be configured to analyze received property models, derive representative values of feature vectors associated with the received property models, and generate improved (e.g., optimized) property models. In addition, the clustering engine may be configured to analyze representative values and cluster the representative values to identify farmable zones.

In some implementations, the clustering system 270 may be configured to infer the existence of farmable zones without executing a clustering process. For instance, the clustering engine 274 may be configured to randomly identify a portion of a property model as a candidate farmable zone. The agronomic simulation interface unit 276 may transmit the candidate farmable zone to the agronomic simulation system 290 and receive an agronomic output from the agronomic simulation system 290. Then, clustering engine 274 can evaluate the received agronomic output to determine if values of one or more agricultural characteristics exceed predetermined thresholds. If values of one or more of the agricultural characteristics fail to exceed the predetermined thresholds, the clustering engine 274 can adjust the boundaries of the candidate farmable zone, and use the agronomic simulation interface unit 276 to request a new agronomic output from the agronomic simulation system 290. This process may iteratively continue until a candidate farmable zone is determined that produces an agronomic output that is associated with values of one or more agricultural characteristics that exceed predetermined thresholds based on the processing of the candidate farmable zone as an agronomic input.

The memory unit 273 may also include software modules related to a mapping system interface unit 275 and an agronomic simulation interface unit 276. The mapping system interface unit 275 is configured to facilitate networked communication between the clustering system 270 and the mapping system 250 via the network 230. For example, the mapping system interface unit 275 may be configured to receive property models 262 from the mapping system 250 through the network 230. Similarly, the agronomic simulation system interface unit 276 is configured to facilitate networked communication between the clustering system 270 and the agronomic simulation system 290 via the network 230. For example, the agronomic simulation system interface unit 276 is configured to transmit data related to one or more farmable zones 264 as an agronomic input to the agronomic simulation system 290 through the network 230, and also receive agronomic outputs from the agronomic simulation system 290 that can be evaluated to determine if one or more crop yields exceed a predetermined threshold.

The agronomic simulation system 290 may include one or more computers that each include at least a processing unit 295 and a memory unit 296. The processing unit 295 includes one or more processors configured to execute the instructions associated with each of one or more software modules stored in the memory unit 296. The memory unit 296 includes one or more storage devices (e.g., RAM, flash memory, storage disks, etc.). The memory unit 296 stores software modules used to perform the actions of methods of the agronomic simulation model described by this specification. In particular, the software modules stored by the memory unit 296 may include modules implementing an agronomic simulation model 297 and a clustering system interface unit 298. The agronomic simulation model 290 may be configured to process agronomic inputs and predict a set of agronomic outputs based on the processing of the agronomic inputs, as discussed herein. The clustering system interface unit 298 may be configured to facilitate networked communication between the agronomic simulation system 290 and the clustering system 270 via the network 230. For example, the clustering system interface unit 298 is configured to receive data related to farmable zones 266 from the clustering system 270 through the network 230. In some implementations, the agronomic simulation system 290 may also include an agronomic database that is similar to agronomic database 259 stored by the mapping system 250.

The system 200 may include one, or multiple, vehicles 210-1, 210-2, 210-n, where “n” is equal to any positive, non-zero integer value. The vehicle 210-1 includes a processing unit 212-1, a memory unit 214-1, a network interface 216-1, and one or more agronomic sensors 218-1. The processing unit 212-1 includes one or more processors that are configured to execute the instructions associated with each of one or more software modules stored in the memory unit 214-1. The memory unit 214-1 includes one or more storage devices (e.g., RAM, flash memory, storage disks, etc.). The memory unit 214-1 stores software modules used to operate the agronomic sensors 218-1. Operation of the agronomic sensors 218-1 includes, for example, powering on an agronomic sensor 218-1, capturing one or more values of one or more agricultural data items using an agronomic sensor 218-1, transmitting the captured values of one or more agricultural data items using the network interface 216-1, etc. The agronomic sensors 218-1 may include one or more sensors configured to detect that a plant has been harvested, obtain the location of the harvested plant (e.g., GPS location), determine the weight of the harvested plant, determine whether the plant is a bean or a kernel, etc. In some implementations, the agronomic sensors 218-1 may also include one or more remote sensing sensors that can be used to capture red-blue-green images, thermal images, infrared images, radar images, or the like. The remote sensing sensors may include, for example, active sensing sensors (e.g., LIDAR or RADAR). In such instances, the agricultural data items 220-1 transmitted may include one or more captured images. The one or more vehicles 210-1, 210-2, 210-n may include, for example, tractors, combines, etc. In the case of remote sensing, the vehicles may include, for example, planes, drones, satellites, etc.

Though FIG. 2 depicts the mapping system 250, the clustering system 270, and the agronomic simulation system 290 as being separate components of the system 200 that are hosted by separate computers or separate groups of computers, the present disclosure need not be so limited. For instance, in one implementation, the mapping system 250, the clustering system 270, and the agronomic simulation system 290 may each be hosted by the same computer, or same group of computers.

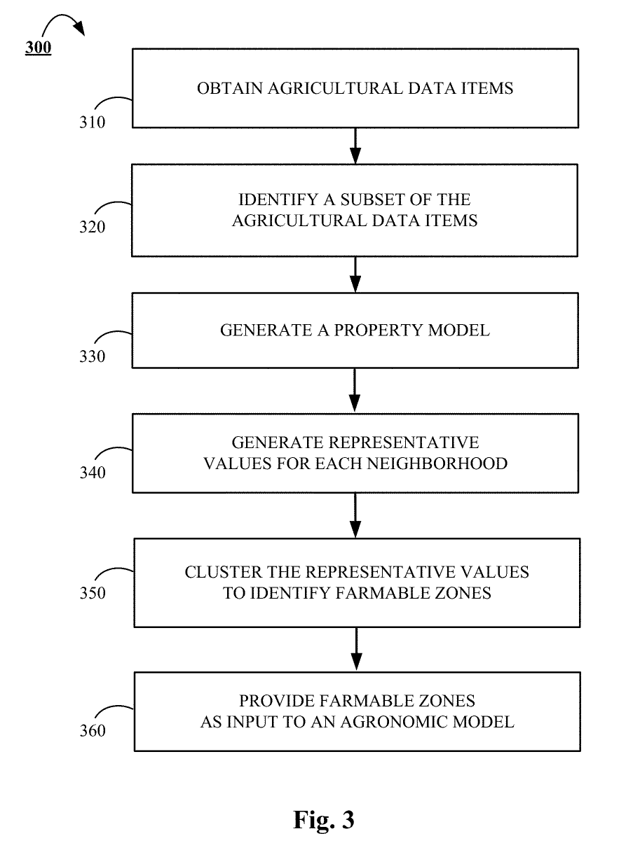

FIG. 3 is a flowchart of an example of a process 300 for improving (e.g., optimizing) inputs to an agronomic simulation model by learning farmable zones, relative to one or more inputs to the agronomic simulation model independent of the learning of the farmable zones. For convenience, the process 300 will be described as being performed by a system of one or more computers located in one or more locations. For example, a system for improving inputs to an agronomic simulation model by learning farmable zones (e.g., the system 200), appropriately programmed in accordance with this specification, can perform the process 300.

The process 300 begins with the system obtaining 310 agricultural data items that describe one or more agricultural characteristics of a field of a farm. For example, the system 100 may receive data from one or more vehicles that have captured data related to the field using one or more agronomic sensors. An agricultural data item may include, for example, the value of an agricultural characteristic and metadata indicating the agricultural characteristic associated with the value. In one implementation, the vehicles may capture agricultural data items related to a particular location of the field at the time the vehicle harvests a plant from the field. For instance, when a plant is harvested, the harvesting vehicle may obtain an item of agricultural data associated with the harvested plant that includes the plant's location (e.g., GPS location), the plant's weight, the plant's time of harvest, etc. Once the agricultural data items are obtained, a feature vector may be derived from each agricultural data item that is obtained.

The system may analyze the derived feature vectors to identify 320 a subset of the feature vectors that can be used to generate a property model. For example, the system may select only the portion of the feature vectors that are associated with values of an agricultural characteristic that exceed a predetermined threshold. Alternatively, or in addition, the system may select only a threshold number of feature vectors associated with each portion of the field of a farm. The selection of a subset of feature vectors may reduce the number of data items used in a property model. The selection of the subset of feature vectors can be made before, or after, a particular property model is generated. For example, a subset of feature vectors can be selected, and then the subset of feature vectors can be used to generate the property model. Alternatively, a property model may be generated using substantially all available feature vectors, and then a subset of the feature vectors in the property model may be identified for retention, with the other feature vectors in the property model being removed from the property model.

The system can generate 330 one or more property models based on the derived feature vectors. Generating a property model may include, for example mapping all, or a subset, of the derived feature vectors onto a vector space model of the field of a farm. The property model may be segmented into a plurality of neighborhoods. In one implementation, the property model may be segmented into multiple, uniformly shaped neighborhoods. Alternatively, the property model may be segmented (e.g., randomly segmented) into multiple neighborhoods of different sizes and shapes. In some implementations, the system may generate multiple different property models for the same field of a farm. For instance, each property model of the multiple property models may be generated based on data about the field that is derived from a different source. For instance, in one implementation, the system may generate a first property model for a field based on agricultural data obtained from the plants in the field at the time of harvest. Alternatively, or in addition, the system may generate a second property model for the field based on remote sensing data. Alternatively, or in addition, the system may generate a third property model for the field based on data obtained from an agronomic database. Other property models may be generated for the field based on data obtained about the field from other sources such as, for example, geological surveys.

The system generates 340 a representative value for each neighborhood of the property model. Generating representative values for each neighborhood in a property model may include, for example, analyzing a set of multiple received property models to determine, for each particular neighborhood, a value representative of the set of feature vectors that are indicative of the characteristics of the particular neighborhood of a field. The representative value may include a representative feature vector that is derived from the feature vectors associated with a particular neighborhood. Representative values may be generated, or otherwise derived, from a set of feature vectors in any suitable way. For instance, in some implementations, a representative value may be randomly selected from the set (or subset) of feature vectors associated with a particular neighborhood. Alternatively, or in addition, the representative value may be generated from the mean of the set (or subset) of feature vectors associated with a particular neighborhood.

The system can cluster 350 the representative values in order to identify one or more agriculturally distinct (e.g., unique) farmable zones. Clustering the representative values may include, for example, analyzing representative values of neighborhoods to cluster together neighborhoods that are associated with representative values that satisfy a predetermined similarity threshold. The representative values may be clustered using one or more clustering processes such as, for example, K-means algorithm, nearest neighbor algorithm, graph cut clustering algorithm, Felsen-Schwab clustering algorithm, Dirichlet process mixture model, Gaussian mixture model, Principal Component Analysis (PCA) with thresholds, Markov Clustering Algorithm (MCL), etc.

The system can provide 360 the one or more agriculturally distinct (e.g., unique) farmable zones as distinct agronomic inputs to an agronomic simulation model. The agronomic simulation model may be distinctly (e.g., uniquely) configured to improve (e.g., maximize) the crop yield of each respective farmable zone as each respective farmable zone is provided as a distinct agronomic input to the agronomic simulation model. Such zone-by-zone analysis may result in a higher crop yield than merely using the agronomic simulation model to analyze a field 105 as being a single, homogeneous region because the agricultural characteristics of each particular farmable zone can be distinctly (e.g., uniquely) addressed to improve (e.g., maximize) each respective farmable zone's output (e.g., crop yield).

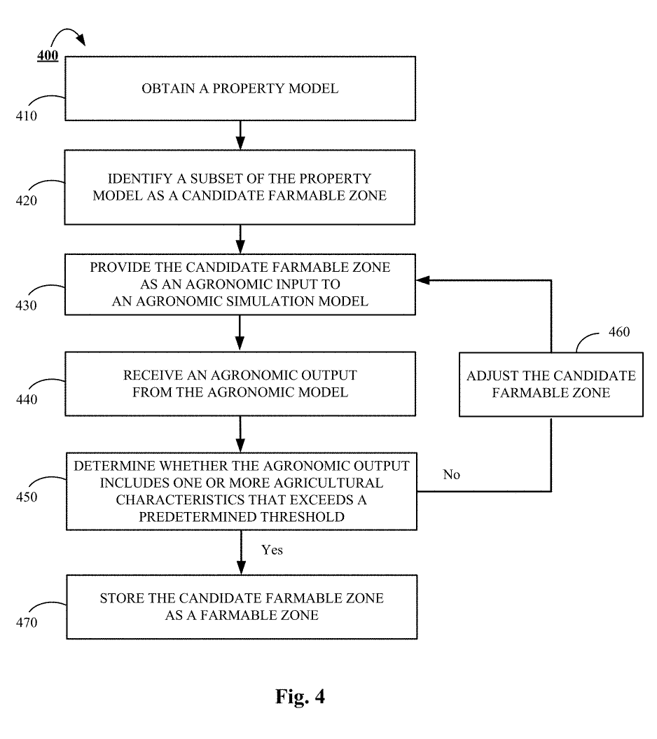

FIG. 4 is a flowchart of an example of a process 400 for inferring the existence of a farmable zone using an agronomic simulation model. For convenience, the process 400 will be described as being performed by a system of one or more computers located in one or more locations. For example, a system for improving inputs to an agronomic simulation model by learning farmable zones (e.g., the system 200), appropriately programmed in accordance with this specification, can perform the process 400.

The process begins at stage 410 with the system obtaining a property model. In one implementation, the obtained property model may include, for example, an improved (e.g., optimized) property model. However, other implementations may utilize a non-improved (e.g.,. non-optimized) property model that includes multiple feature vectors per neighborhood.

The system can identify 420 a subset of the property model as a candidate farmable zone. The candidate farmable zone may include, for example, a portion of the property model that spans one or more representative values, one or more neighborhoods, etc. In some implementations, the candidate farmable zone may be randomly determined. Alternatively, other implementations may begin with a candidate farmable zone of a predetermined size and location. In some implementations, a user may input the parameters of candidate farmable zone such as the candidate farmable zone's size, shape, location, and the like. In other implementations, the candidate farmable zone's parameters may be generated automatically by one or more components of a system (e.g., system 200).

The system can provide 430 the candidate farmable zone as an agronomic input to an agronomic model. An agronomic simulation model may process the agronomic input that includes the identification of the candidate farmable zone, and predict a set of agronomic outputs based on processing of the agronomic input. The agronomic output is received 440 by the system.

After receiving the agronomic output, the system can determine 450 whether the agronomic output includes one or more agricultural characteristics having values greater than a predetermined threshold. In one implementation, for example, the system may determine whether a value associated with one or more crop yields for the candidate farmable zone exceeds a predetermined threshold. If it is determined that a value for one or more agricultural characteristics does not exceed a predetermined threshold, then the process continues at stage 460 where the system can adjust the values of one or more parameters of the candidate farmable zone. Adjusting the values of one or more parameters of the candidate farmable zone may include, for example, adjusting the size, location, or both of the candidate farmable region. In one implementation, the adjustments to the values of one or more parameters of the candidate farmable zone may be applied randomly. Alternatively, or in addition, the adjustments to the values of one or more parameters of the candidate farmable zone may be based on, for example, historical data from an agronomic database associated with the field where the candidate farmable zone resides.

Once the values of the one or more parameters of the candidate farmable zone have been adjusted, the process 400 may repeat stages 430, 440, and 450 using the adjusted candidate farmable zone. For instance, the adjusted candidate farmable zone may be provided at stage 430 as an agronomic input to an agronomic simulation model and the system may receive 440 an agronomic output predicted by the agronomic simulation model based on processing the adjusted candidate farmable zone as an agronomic input. Then, the system may determine 450 whether the agronomic output includes one or more agricultural characteristics having values greater than a predetermined threshold. If it is determined that a value of one or more agricultural characteristics in the agronomic output does not exceed a predetermined threshold, the process is repeated again by adjusting the candidate farmable zone at stage 460 and subsequently repeating stages 430, 440, and 450.

Alternatively, if it is determined 450, during a first, or subsequent, iteration through the process 400, that the agronomic output includes one or more agricultural characteristics having values that exceed a predetermined threshold, the process may continue to stage 470 when the candidate farmable zone is stored as a farmable zone. Then, the stored candidate farmable zone can be used as an agronomic input to the agronomic simulation model to help make real world farming decisions in the field of the farm that includes the farmable zone. Since farming decisions can be specifically tailored to the agricultural characteristics of the inferred farmable zone, the agronomic outputs associated with the field (e.g., one or more crop yields) may be improved (e.g., maximized).

In the example of FIG. 4, and other examples described herein, once the simulation is used to develop an agronomic plan for the field that has been fully developed to improve (e.g., maximize) a field's crop yield, the agronomic plan may be implemented on the real-world field by preparing the field, planting crops in the field, treating the planted crops, and harvesting the planted crops in accordance with agronomic input to the agronomic simulation model that predicted an agronomic output having improved (e.g., maximized) crop yields.

In some implementations, the subject matter of the present disclosure may be used to generate a stability map. Generating a stability map may include, for example, analyzing the variance in the values corresponding to one or more agronomic characteristics across multiple neighborhoods N0 . . . Nm that each share at least one common boundary with another of the neighborhoods N0 . . . Nm. An “unstable region” may be a homogeneous region that may obscure some underlying heterogeneity. For instance, by way of example, two neighboring patches could both have high variance through time and thus both be marked “unstable” even though Patch A is high yielding in high precipitation years and low yielding in low precipitation years, while Patch B is high yielding in low precipitation years and low yielding in high precipitation years.

Generating such a stability map may involve altering the clustering methods described herein, because some implementations described hereinabove may determine that Patch A and Patch B are two different farmable zones. Modifying the clustering process described herein to generate a stability map by analyzing the variance in values corresponding to one or more agronomic characteristics across multiple neighborhoods sharing at least one common boundary enables the clustering process to identify neighborhoods that can be merged into a single farmable zone that would otherwise be left as separate farmable zones. In such implementations, a first neighborhood may be determined to be agriculturally similar to a second neighborhood based on the overall stability that is achieved between the first neighborhood and the second neighborhood. Alternatively, a stability map as described above may be generated without clustering.

In some implementations, stability maps (e.g., zones) may be generated based on data obtained from one or more remote sensing devices. Such stability zones may be determined by, for example, determining the mean and the standard deviation through time of a series of inputs.

The inputs may include yield maps. Alternatively, or in addition, the inputs may be images from one or more remote sensing devices. Alternatively, or in addition, the system may mean-center each image to normalize it. Alternatively, or in addition, the system may determine the standard deviation of the pixels (e.g., normalized pixels) through time. In some implementations, ranges of the mean and ranges of the standard deviation may define the zones. For example, zones with standard deviation≧a threshold value (e.g., 15) may be classified as “unstable,” zones with standard deviation<the threshold value may be classified as “stable.” Zones with means less than a first threshold (e.g., −10) may be classified as “low,” zones with means greater than a second threshold (e.g., 10) may be classified as “high,” and zones with means between the first and second thresholds may be classified as “medium.” Using this classification scheme, six types of zones may be identified (e.g., unstable/low, unstable/medium, unstable/high, stable/low, stable/medium, and stable/high).

In some implementations, the remote sensing data may include, for example, normalized difference vegetation index (NDVI). NDVI may be collected multiple times over a predetermined time period (e.g., a month, multiple months, a year, etc.). One or more of these images at different times may be used to compute the maps. One or more of the images may be excluded from the set used to compute the maps. For instance, an image may be excluded if the image includes, for example, clouds. One or more functions may select which image(s) to use. Such functions may, for example, perform one or more operations such as improving (e.g., maximizing) the amount of contrast of the image of the field. In some implementations, the functions may perform such operations only for pixels that represent plants. Alternatively, the function may instead be based on the growth stage of the plant. The model may be executed for the time period (e.g., year) on a periodic (e.g., daily) timestep to predict the plant growth stage for each period (e.g., day), and the predictions (e.g., predicted developmental stage) for a particular period (e.g., day) may be compared to the corresponding image(s) for that period (e.g., day), if any. An image may not exist for every period (e.g., day). In some implementations, the function for choosing the image to use may be based on trying to find the image closest to a given developmental stage of the crop, for instance V8 for corn, V6 for corn, or the like.

Alternatively, or in addition, elevation data may be used to analyze the agronomic characteristics of a particular geographic region. Elevation data may be analyzed using, for example, a high resolution Digital Elevation Model. The high resolution Digital Elevation Model may include a layer of surface height at every pixel. Alternatively, or in addition, the Digital Elevation Model may be based on irregular pixels or polygons. Alternatively, or in addition, other resolutions can be used.

Alternatively, or in addition, a water shedding model may be used to analyze agronomic characteristics of a particular geographic region. A water shedding model may include, for example, D-Infinity. In some implementations, the water shedding model may consider soil infiltration, evaporation, plant water use, etc. as the water moves to calculate the water flow along a field. Alternatively, or in addition, the water shedding model may account for lateral flow to calculate the water flow along a field. Alternatively, or in addition, the water shedding model may consider the effects of farm field drainage lines, waterways or streams in the model. Alternatively, or in addition, the water shedding model may consider areas outside the geographic region of interest draining to or from the geographic region under consideration. Alternatively, or in addition, the water shedding model may consider the different infiltration rates of water into the soil (and thus, e.g., decreasing the amount of runoff) of different soil zones across the geographic region (e.g., a sandier zone through which water filters faster, thus contributing less water flow runoff to other zones). Alternatively, or in addition, the water shedding model may consider the current saturation level of the soil in each of these zones to alter the amount of runoff (e.g., if a region is already saturated, more water runs off, and this is a quantitative effect over different levels of soil saturation). This may be computed from a soil hydrology model and the actual or simulated weather to date. Alternatively, or in addition, in determining the amount of runoff, the water shedding model may consider plant water uptake and evaporation. Alternatively, or in addition, the water shedding model may consider capillary action of soil drawing water up from below. The water shedding model may account for the “intensity” of the rain. The “intensity” of the rain may include, for example, the spacing of the rainfall in time. For example, if 2 cm of rain falls over only 2 minutes instead of over 2 hours, more runoff may occur as there is not enough time for as much water to intercalate into the soil. This may be, for example, actual spacing in time such as from hourly data or higher resolution in time RADAR or other measurement modalities, or it may be a proxy variable. For example, in the U.S., rainfall is generally more intense in the summer than in the winter.

In some implementations, the soil hydraulic conductivity (e.g., the rate that water can move through the soil) of each patch of soil can be used to calculate some amount of incident water absorbed and some amount of runoff. Alternatively, or in addition, the model could model some water coming up from capillary action, some water drawn up by plants, some water lost due to evaporation etc. During a precipitation event, each soil patch may be both receiving incoming precipitation and possibly contributing runoff to some of its neighbors.

In some implementations, a total amount of runoff may be transitively calculated for each pixel. Some amount of the incident rain may be absorbed by soil patch A, some amount may run off to soil patch B, and in some instances, another amount may run off into one or more other soil patches. Soil patch B may also have its own same incident rain, to which the runoff from Soil Patch A, and possibly other tiles, may be added. Some amount of this total may be absorbed into the soil at patch B, and some amount may run off to soil Patch C (and possibly others).

In some implementations, an “incident water mask” that accounts for the flow induced by topography can be calculated. The incident water mask may include a raster (e.g., a set of pixels that cover a geographic region (e.g., a farm field)) or vector (e.g., set of polygons that cover the geographic region (e.g., a farm field)) of weights, such that the Expectation (e.g., probability theory expectation such as the area-weighted mean) is 1. For example, if there exists R centimeters of rain on a geographic region (e.g., field), instead of assigning every zone of the geographic region (e.g., field) where the model is run to experience R cm of rain, the model can multiply that R cm by the corresponding water mask polygon's weight and use the resulting value as the rain for the model. For example, a geographic region (e.g., field) may have a depression in the center. Because the soil has some moisture and cannot absorb all of the incident rain at every point in space, some of the rain may run off of the soil surface and into the depression. This may result in the upper zone of the field experiencing only X<R cm of rain, and the depression experiencing Y>R cm of rain.

A static mask may be created to use for running the model. This static mask may be computed every hour and be used to simulate the entire soil hydrology system to supply soil moisture to the model.

Alternatively, or in addition, a much smaller series of masks may be computed in an effort to improve the computational efficiency of the above hourly process. For example, a mask could be computed for each month of the year. The mask, in at least one example, may correspond to one or more determinations of rainfall intensity. Alternatively, or in addition, the mask could be computed for each of the product of a series of aggregate initial soil moisture levels times the series of months of the year, thus taking into account 2 variables—e.g., the existing soil moisture (e.g., more initial moisture yields more runoff) and the rainfall intensity (e.g., greater intensity of rainfall yields more runoff). Alternatively, or in addition, the system can compute a single mask with an aggregate value of initial soil moisture (e.g., average soil moisture during the growing season) and an aggregate value of rainfall intensity (e.g., average value of rainfall intensity during the growing season). In any of these cases, the soil water content for each zone can be initialized, and then a rainfall event can be run in simulation using the specified rainfall intensity. The time to move runoff water between soil patches may occur in either continuous or discrete time. It may be assumed that this water transfer time is zero. Assuming the transfer time is zero can improve the computational efficiency of the process versus assuming steps in time.

In some implementations, all of the zones may be represented using a transition matrix. For example, each cell of the matrix may represent an amount of flow of water from a soil patch indicated by the row label of the matrix to the soil patch indicated by the column label of the matrix. When the row and column labels of a matrix cell are the same, that cell indicates the amount of water that will remain on the associated soil patch, and/or be absorbed into the soil. Such implementations may not be sensitive to the choice of flow direction from row patches to column patches. Alternatively, a flow may be expressed as from column patches to row patches. Alternatively, the flow may be represented as a weighted graph of soil patch nodes and edges with the transfer weight. In such an implementation, each row is normalized such that the values in the row sum to 1, meaning that the percentage of the water that flows to any of the other nodes or stays at the current node sums to 1, meaning that water is conserved (e.g., not created or destroyed). In this way the flow matrix may be a probability matrix. The matrix may be construed to represent a Markov chain, and the long term equilibrium state may be computed by, for example, being approximated by matrix exponentiation, solved using the inverse of the transition matrix, etc.

The generated mask (or masks), as it takes into account the different soil polygons/rasters for each farm field and thus the different soil hydrological processes (e.g., different intercalation rates), may be different for every field.

In some implementations, the system may construct a field specific water mask, collect precipitation data (and potentially other data) to run a crop model, multiply the mask by the precipitation data to create a modified per-zone incident rain value, use the modified value as input to the crop model, and predict one or more agronomic outputs based on the inputs to the crop model.

### Further Description of Some Embodiments

Agronomic inputs can include both a type of agronomic input (e.g., sandiness) and a value for the agronomic input (e.g., 20%). In general, a change in an agronomic input refers to a change in the value for the agronomic input. Examples of agronomic inputs can include, but are not limited to: maximum ponding height; soil layer depth; saturated soil water content; soil bulk density; soil organic carbon content; soil clay content; soil sand content; soil silt content; soil stones (coarse fragment) content; lower limit of soil water availability; drained upper limit of soil water availability; saturated soil hydraulic conductivity; soil nitrogen content; soil pH; soil cation exchange capacity; soil calcium carbonate content; soil fresh organic matter (FOM) carbon, nitrogen and phosphorus content; soil active inorganic carbon content; soil slow inorganic carbon content; soil active inorganic phosphorus content; soil slow inorganic phosphorus content; soil mineral nitrogen including nitrate, ammonia and urea; air temperatures (including minimum and/or maximum); soil temperatures (including minimum and/or maximum); storm intensity (tightness of precipitation in time, for example, 1″ over 5 hours or in 5 minutes); elevation; solar radiation; precipitation; relative humidity; planting date; planting window dates; temperate thresholds for planting; soil moisture thresholds for planting; crop row spacing; planting depth; crop species; crop variety/cultivar; yield components of the variety/cultivar (for example, beans per pod, pods per plant, kernels per ear, ears per plant, etc.); length of developmental stages of variety/cultivar; compression of developmental stages of variety/cultivar; planting density; field irrigation; irrigation event water volume; irrigation event dates; irrigation drain depth; irrigation drain spacing; fertilizer date; fertilizer amount; fertilizer type (for example, manure, anhydrous ammonia, etc.); chemical composition of fertilizer type; fertilizer application depth; fertilizer incorporation percentage; harvest date; percent of stalk/leaves knocked down at harvest; percent of plant by-product harvested (leaves, etc.); percent of grain/fiber/fruit/etc. harvested; insect activity; plant hypoxia; weed growth; disease.

Agronomic outputs can include both a type of agronomic output (e.g., crop yield) and a value for the agronomic output (e.g., 175 bushels/acre). In general, a change in an agronomic output refers to a change in the value for the agronomic output. Examples of agronomic outputs may include, but are not limited to, crop yield; sustainability; environmental impact; length of developmental stages of variety/cultivar; yield; leaf area index (LAI) over time; damage/death to the crop by frost, anoxia, heat, drought, etc.; dry weight of grains/fiber/fruit/veg; dry weight of shoots/areal plant parts; root depth; total root dry weight; change in biomass from previous time slice; daily and accumulated thermal time; radiation use efficiency; relative thermal time to maturity; current plant development phase; root weight, and of tillers; grain weight, and of tillers; total accumulated leaves or their equivalents; total accumulated phylochron intervals; leaf weight, and of tillers; weight of stem reserves, and of tillers; weight of stems, and of tillers; sink weight; source weight; below ground active organic nitrogen, carbon, phosphorus; below ground active inorganic nitrogen, carbon, phosphorus; atmospheric CO_{2;} below ground fertilizer nitrogen, carbon, phosphorus; carbon in cumulative CO₂ evolved; cumulative nitrogen fixed; cumulative harvested plant nitrogen and phosphorus; total nitrogen, carbon, phosphorus additions; below ground labile nitrogen and phosphorus; net nitrogen, carbon, phosphorus change; total nitrogen, carbon, phosphorus withdrawals; cumulative plant uptake of nitrogen and phosphorus; above ground rapid FOM nitrogen, carbon, phosphorus; below ground rapid FOM nitrogen, carbon, phosphorus; below ground resistant organic nitrogen, carbon, phosphorus; above ground interim FOM carbon; below ground interim FOM carbon; above ground slow FOM nitrogen, carbon; below ground slow FOM nitrogen, carbon; below ground slow organic nitrogen, carbon; below ground slow inorganic nitrogen, carbon; below ground solution nitrogen, phosphate; recognizable standing dead nitrogen, carbon, phosphorus; total nitrogen that can volatize; inorganic nitrogen in soil; cumulative nitrogen leached; organic nitrogen in soil; total nitrogen volatized; cold stress; drought; drought in stomatal conductivity; drought in turgidity; heat stress; nitrogen stress; phosphorus stress; photoperiod factor; cumulative drainage; potential cumulative evapotranspiration; potential evapotranspiration daily; cumulative plant transpiration; plant transpiration daily; cumulative soil evaporation; soil evaporation daily; cumulative evapotranspiration; evapotranspiration daily; cumulative irrigation; ponding height current; ponding height maximum; cumulative precipitation; cumulative runoff; potentially extractable water; and water table depth.

Agronomic inputs can be broken down by soil layer (e.g., by depth), over different time periods (for example, daily), and/or laterally (e.g., by location on a field). Lateral granularity can account for changes across a field or across multiple fields, such as changes in soil conditions, different crop/cultivar plantings in different locations on the same field, or other changes. For example, for every soil layer and for every time period agronomic outputs can also include, but are not limited to: new bulk density; downward water flux; net water flow; inorganic nitrogen in soil; root water uptake; dry weight of roots in the layer; soil temp; soil water content; soil hydraulic conductivity; upward water flux; active, slow, resistant organic carbon content's rapid, intermediate, and slow; total fresh organic matter content; soil carbon content; CO₂ sequestration; active, slow and resistant organic nitrogen contents; ammonia content; N₂O content; nitrogen content; urea content.

The agronomic simulator simulates agronomic activity based on provided agronomic inputs. The agronomic activity can be simulated using an agronomic model, such as the SYSTEM APPROACH TO LAND USE SUSTAINABILITY (SALUS) model or the CERES model. The SALUS model can model continuous crop, soil, water, atmospheric, and nutrient conditions under different management strategies for multiple years. These strategies may have various crop rotations, planting dates, plant populations, irrigation and fertilizer applications, and tillage regimes. The model can simulate plant growth and soil conditions every day (during growing seasons and fallow periods) for any time period when weather sequences are available or assumed. The model can account for farming and management practices such as tillage and residues, water balance, soil organic matter, nitrogen and phosphorous dynamics, heat balance, plant growth, plant development, presence of biotech traits, application of fungicides, application of pesticides, application of antimicrobials, application of nucleic acids, and application of biologicals. The water balance can consider surface runoff, infiltration, surface evaporation, saturated and unsaturated soil water flow, drainage, root water uptake, soil evaporation and transpiration. The soil organic matter and nutrient model can simulate organic matter decomposition, nitrogen mineralization and formation of ammonium and nitrate, nitrogen immobilization, gaseous nitrogen losses, and three pools of phosphorous.

The agronomic simulator can use any process or model that can predict agronomic outputs based on provided agronomic inputs. For instance, the agronomic simulator can use a physical, generative or mechanistic model; a purely statistical or machine learning model; or a hybrid. In an example, the agronomic simulator can use a model that predicts agronomic outputs by attempting to match (by exact match or approximate match using, for instance, nearest neighbor) the provided agronomic inputs or a transformation or function thereof (e.g., a dimensionality reduction, such as Principle Components Analysis or the outputs of an Indian Buffet Process or other latent factor model) with a collection of previously observed inputs and their matching outputs, and predicting the output of the matched input.

In some examples, an agronomic simulator can use one or more non-analytic functions. An analytic function can be locally represented by a convergent power series; a non-analytic function cannot be locally represented by a convergent power series.

Further description of the agronomic simulator is provided in U.S. patent application Ser. No. 15/259,030, titled “Agronomic Database and Data Model” and filed on Sep. 7, 2016, the contents of which are hereby incorporated by reference herein to maximum extent permitted by applicable law.

In some examples, some or all of the processing described above can be carried out on a personal computing device, on one or more centralized computing devices, or via cloud-based processing by one or more servers. In some examples, some types of processing occur on one device and other types of processing occur on another device. In some examples, some or all of the data described above can be stored on a personal computing device, in data storage hosted on one or more centralized computing devices, or via cloud-based storage. In some examples, some data are stored in one location and other data are stored in another location. In some examples, quantum computing can be used. In some examples, functional programming languages can be used. In some examples, electrical memory, such as flash-based memory, can be used.

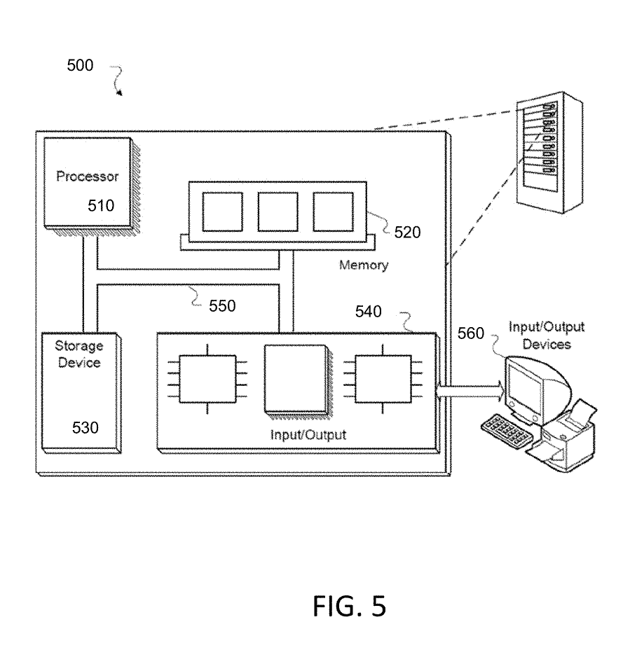

FIG. 5 is a block diagram of an example computer system 500 that may be used in implementing the technology described in this document. General-purpose computers, network appliances, mobile devices, or other electronic systems may also include at least portions of the system 500. The system 500 includes a processor 510, a memory 520, a storage device 530, and an input/output device 540. Each of the components 510, 520, 530, and 540 may be interconnected, for example, using a system bus 550. The processor 510 is capable of processing instructions for execution within the system 500. In some implementations, the processor 510 is a single-threaded processor. In some implementations, the processor 510 is a multi-threaded processor. The processor 510 is capable of processing instructions stored in the memory 520 or on the storage device 530.

The memory 520 stores information within the system 500. In some implementations, the memory 520 is a non-transitory computer-readable medium. In some implementations, the memory 520 is a volatile memory unit. In some implementations, the memory 520 is a non-volatile memory unit.

The storage device 530 is capable of providing mass storage for the system 500. In some implementations, the storage device 530 is a non-transitory computer-readable medium. In various different implementations, the storage device 530 may include, for example, a hard disk device, an optical disk device, a solid-date drive, a flash drive, or some other large capacity storage device. For example, the storage device may store long-term data (e.g., database data, file system data, etc.). The input/output device 540 provides input/output operations for the system 500. In some implementations, the input/output device 540 may include one or more of a network interface devices, e.g., an Ethernet card, a serial communication device, e.g., an RS-232 port, and/or a wireless interface device, e.g., an 802.11 card, a 3G wireless modem, or a 4G wireless modem. In some implementations, the input/output device may include driver devices configured to receive input data and send output data to other input/output devices, e.g., keyboard, printer and display devices 560. In some examples, mobile computing devices, mobile communication devices, and other devices may be used.

In some implementations, at least a portion of the approaches described above may be realized by instructions that upon execution cause one or more processing devices to carry out the processes and functions described above. Such instructions may include, for example, interpreted instructions such as script instructions, or executable code, or other instructions stored in a non-transitory computer readable medium. The storage device 530 may be implemented in a distributed way over a network, for example as a server farm or a set of widely distributed servers, or may be implemented in a single computing device.

Although an example processing system has been described in FIG. 5, embodiments of the subject matter, functional operations and processes described in this specification can be implemented in other types of digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “system” may encompass all kinds of apparatus, devices, and machines for processing data, including by way of example a programmable processor, a computer, or multiple processors or computers. A processing system may include special purpose logic circuitry, e.g., an FPGA (field programmable gate array) or an ASIC (application specific integrated circuit). A processing system may include, in addition to hardware, code that creates an execution environment for the computer program in question, e.g., code that constitutes processor firmware, a protocol stack, a database management system, an operating system, or a combination of one or more of them.

A computer program (which may also be referred to or described as a program, software, a software application, a module, a software module, a script, or code) can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program can include, by way of example, general or special purpose microprocessors or both, or any other kind of central processing unit. Generally, a central processing unit will receive instructions and data from a read-only memory or a random access memory or both. A computer generally includes a central processing unit for performing or executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps or stages may be provided, or steps or stages may be eliminated, from the described processes. Accordingly, other implementations are within the scope of the following claims.

### Terminology

The phraseology and terminology used herein is for the purpose of description and should not be regarded as limiting.

The term “approximately”, the phrase “approximately equal to”, and other similar phrases, as used in the specification and the claims (e.g., “X has a value of approximately Y” or “X is approximately equal to Y”), should be understood to mean that one value (X) is within a predetermined range of another value (Y). The predetermined range may be plus or minus 20%, 10%, 5%, 3%, 1%, 0.1%, or less than 0.1%, unless otherwise indicated.

The indefinite articles “a” and “an,” as used in the specification and in the claims, unless clearly indicated to the contrary, should be understood to mean “at least one.” The phrase “and/or,” as used in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The use of “including,” “comprising,” “having,” “containing,” “involving,” and variations thereof, is meant to encompass the items listed thereafter and additional items.

Use of ordinal terms such as “first,” “second,” “third,” etc., in the claims to modify a claim element does not by itself connote any priority, precedence, or order of one claim element over another or the temporal order in which acts of a method are performed. Ordinal terms are used merely as labels to distinguish one claim element having a certain name from another element having a same name (but for use of the ordinal term), to distinguish the claim elements.

What is claimed is:

1. A method for learning farmable zones comprising:
obtaining agricultural data items from a device configured for agricultural analysis in a particular geographic region;
identifying, from the obtained agricultural data items, a subset of the agricultural data items;
generating a property model based on (i) the particular geographic region, and (ii) the subset of the agricultural data items; and
generating a plurality of farmable zones that are each agriculturally distinct based on the subset of the agricultural data items.

2. The method of claim 1, further comprising:
segmenting the generated property model of the particular geographic region into a plurality of neighborhoods.

3. The method of claim 2, wherein the plurality of neighborhoods is a plurality of substantially same sized neighborhoods.

4. The method of claim 2, wherein segmenting the generated property model into the plurality of neighborhoods comprises randomly segmenting the generated property model into the plurality of neighborhoods.

5. The method of claim 2, wherein each neighborhood comprises a respective portion of the particular geographic region with one or more territorial boundaries that fall within the particular geographic region.

6. The method of claim 1, wherein identifying a subset of the agricultural data items from the obtained agricultural data items includes removing one or more of the obtained agricultural data items each associated with a value of an agricultural characteristic that falls below a predetermined threshold.

7. The method of claim 2, wherein identifying a subset of the multiple agricultural data items from the obtained agricultural data items includes selecting, for each of the neighborhoods, a subset of a set of the obtained agricultural data items that correspond to the respective neighborhood.

8. The method of claim 2, further comprising:
for each particular neighborhood:
generating a representative value for the particular neighborhood.

9. The method of claim 8, further comprising:
for each particular neighborhood:
determining a mean of values of the agricultural data items residing within the particular neighborhood, wherein the representative value for the particular neighborhood is generated based on the determined mean.

10. The method of claim 1, wherein obtaining agricultural data items from a device configured for agricultural analysis in a particular geographic region includes:
receiving agricultural data from one or more harvesting machines.

11. The method of claim 1, wherein obtaining agricultural data items further includes:
obtaining, for each harvested plant, a set of agricultural data items;
wherein the set of obtained agricultural data items for each harvested plant includes (i) one or more particular agricultural characteristics, (ii) a location, and (iii) a harvest time for the harvested plant.

12. The method of claim 11, wherein the one or more particular agricultural characteristics include a weight of the harvested plant, an indication of whether the harvested plant was a bean, an indication of whether the harvested plant was a kernel, and/or a biomass of the harvested plant.

13. The method of claim 11, wherein the location includes a GPS location of a harvested plant at the time of harvest.

14. The method of claim 11, wherein the harvest time includes a date when a harvested plant was harvested.

15. The method of claim 1, wherein generating a plurality of farmable zones that are each agriculturally distinct based on the subset of the agricultural data items includes:
generating one or more clusters of agricultural data items based on at least a threshold amount of similarity in one or more agricultural characteristics amongst the subset of the agricultural data items.

16. The method of claim 15, further comprising:
for each cluster, merging neighborhoods that are encompassed by the cluster to create a farmable zone.

17. The method of claim 8, wherein generating a plurality of farmable zones that are each agriculturally distinct based on the subset of the agricultural data items includes:
generating one or more clusters of agricultural data items based on the representative value of each neighborhood.

18. The method of claim 17, further comprising:
for each cluster, merging neighborhoods that are encompassed by the cluster to create a farmable zone.

19. The method of claim 1, further comprising:
providing the plurality of farmable zones as input to an agronomic simulation model.

20. The method of claim 19, further comprising:
for each input provided to the agronomic simulation model:
tuning one or more values of one or more parameters of the agronomic simulation model based on an agriculturally distinct farmable zone on which the input is based.

21. The method of claim 17, wherein the one or more clusters are generated using one or more of a K-means algorithm, a nearest neighbor algorithm, a graph cut clustering algorithm, a Felsen-Schwab clustering algorithm, a Dirichlet process mixture model, a Gaussian mixture model, a Principal Component Analysis (PCA) with thresholds, and a Markov Clustering Algorithm (MCL).

22. A method for inferring one or more farmable zones, the method comprising:
obtaining a property model;
identifying a portion of the property model as a candidate farmable zone;
providing the candidate farmable zone as an agronomic input to an agronomic simulation model;
receiving an agronomic output from the agronomic simulation model, the agronomic output being based on processing of the agronomic input;
determining whether the agronomic output includes one or more agricultural characteristics with one or more respective values that exceed a predetermined threshold; and
in response to determining that the agronomic output does not include one or more agricultural characteristics with one or more respective values that exceed the predetermined threshold, adjusting one or more values of one or more parameters associated with the candidate farmable zone to create an adjusted candidate farmable zone.

23. The method of claim 22, further comprising:
providing the adjusted candidate farmable zone as a second agronomic input to the agronomic simulation model;
receiving a second agronomic output from the agronomic simulation model, the second agronomic output being based on processing of the second agronomic input;
determining whether the second agronomic output includes one or more values of one or more agricultural characteristics that exceed a predetermined threshold; and
in response to determining that the second agronomic output includes one or more values of one or more agricultural characteristics that exceed the predetermined threshold, inferring that the adjusted candidate farmable zone is a farmable zone.

24. The method of claim 22, wherein identifying a subset of the property model as a candidate farmable zone includes:
identifying a portion of the property model as a candidate farmable zone.

25. The method of claim 22, wherein one or more agricultural characteristics include a predicted crop yield.

26. The method of claim 22, wherein determining whether the agronomic output includes one or more values of one or more agricultural characteristics that exceeds a predetermined threshold includes:
determining whether the agronomic output includes data indicating whether one or more crop yield values exceed the predetermined threshold.

27. The method of claim 22, wherein adjusting the one or more values of the one or more parameters associated with the candidate farmable zone to create an adjusted candidate farmable zone includes:
adjusting a size of the candidate farmable zone and/or adjusting a location of the candidate farmable zone.

28. The method of claim 22, wherein adjusting the one or more values of the one or more parameters associated with the candidate farmable zone to create an adjusted candidate farmable zone includes:
randomly adjusting a size of the candidate farmable zone and/or randomly adjusting a location of the candidate farmable zone.

29. A system comprising:
one or more computers and one or more storage devices storing instructions that are operable, when executed by the one or more computers, to cause the one or more computers to perform operations comprising:
obtaining agricultural data items from a device configured for agricultural analysis in a particular geographic region;
identifying, from the obtained agricultural data items, a subset of the agricultural data items;
generating a property model based on (i) the particular geographic region, and (ii) the subset of the agricultural data items; and
generating a plurality of farmable zones that are each agriculturally distinct based on the subset of the agricultural data items.

30. A system comprising:
one or more computers and one or more storage devices storing instructions that are operable, when executed by the one or more computers, to cause the one or more computers to perform operations comprising:
obtaining a property model;
identifying a portion of the property model as a candidate farmable zone;
providing the candidate farmable zone as an agronomic input to an agronomic simulation model;
receiving an agronomic output from the agronomic simulation model, the agronomic output being based on processing of the agronomic input;
determining whether the agronomic output includes one or more agricultural characteristics with one or more respective values that exceed a predetermined threshold; and
in response to determining that the agronomic output does not include one or more agricultural characteristics with one or more respective values that exceed the predetermined threshold, adjusting one or more values of one or more parameters associated with the candidate farmable zone to create an adjusted candidate farmable zone.
